(19) United States
(12) Patent Application Publication
(10) Pub. No.: US 2003/0051012 A1
(43) Pub. Date: Mar. 13, 2003

(54) Method and system for online plug-and-play driver installation

(75) Inventor: I-Larn Chen, Taipei (TW)

Correspondence Address: VOLPE AND KOENIG, P.C., SUITE 400, ONE PENN CENTER, 1617 JOHN F. KENNEDY BOULEVARD, PHILADELPHIA, PA, 19103, US

(73) Assignee: VIA Technologies, Inc., Taipei (TW)

(21) Appl. No.: 10/160,455

(22) Filed: May 31, 2002

(30) Foreign Application Priority Data
Sep. 7, 2001 (TW) 90122293

(51) Int. Cl. G06F 15/177; G06F 9/00

(52) U.S. Cl. 709/221; 713/1

(57) ABSTRACT

A method and system for online plug-and-play (PnP) driver installation is presented. The steps for accomplishing the online PnP driver installation according to the present invention is involved with the following steps of building a driver database in a network host, enabling a data processing machine to establish a connection with the network host through a computer network, executing a driver detection program to generate a detection result, creating a driver package from the driver database in accordance with the detection result being transferred to the network host, and transferring the driver package to the data processing machine and executing the driver package by the data processing machine.

### FIELD OF THE INVENTION

The present invention is related to a method and system for online driver installation, and more particularly to a method and system for plug-and-play (PnP) driver installation in a data processing machine through a computer network.

### BACKGROUND OF THE INVENTION

With the popularization and prevalence of Internet, most of the hardware device drivers that provide an interface between an application program and hardware devices can be downloaded and updated from remote side server. Because integrated chipset is becoming more and more popular, a large number of contributions have been made to the so-called four-in-one, five-in-one or six-in-one integrated chipset development that offers a versatile integration solution. Under this condition, an integrated chipset that incorporates numerous specific features of system I/O devices therein, such as sound card, display card or network card, is usually combined with a driver package containing several individual drivers that are inseparable from each one another and occupies a chunk of data amount. However, if the driver package is enabled to provide multiple language support (for example, the hardware device drivers provided by Windows 2000 or Windows CE operating system), its data amount will be quite sizable up to the extent of several megabytes, tens of megabytes or even more. Therefore lots of time will be consumed during driver installation process.

On the other hand, most of the current hardware devices are compliant with plug-and-play (commonly known as PnP) specification, namely, the hardware device is allowed to be plugged in and immediately be enabled to use it without maneuvers. As a result, the user may download the desired PnP device driver from Internet and immediately proceed with the driver installation operation. In the prior art, however, when the user desires to update the driver of a hardware device (such as a display card), it is unavoidable that the driver package of great data amount is needed to be completely downloaded to the local side computer, such that the user can complete the update to the hardware device driver. In this way, other unnecessary drivers will also be downloaded and installed. Further, for each driver installation process, similar welcome message and legal proclamation will be displayed. In this manner, when the driver installation or update operation is proceeded by using a complete drive package containing numerous hardware device drivers, welcome message and legal proclamation will be displayed repetitively for several times. For instance, if a six-in-one driver package is to be installed, the information associated with the welcome message and legal proclamation of the individual driver will be displayed for six times throughout the driver installation process. Obviously, these redundant operations will be carried into execution repeatedly, and the user still has to waste time on these trivial and senseless matters.

### SUMMARY OF THE INVENTION

In the face of the shortcomings of wasted works and redundant operations encountered by the conventional online driver installation process, the present invention provides a method and system for online hardware device driver installation. A first respect of the present invention is connected with the presentation of a method for configuring a hardware device in a data processing machine from a network host, comprising the following steps of: building a driver database in the data processing machine, enabling the data processing machine to establish a connection with the network host through a computer network, executing a driver detection program by the data processing machine to detect the category and number of the drivers that are requested to be installed or updated and in response thereto generating a detection result, transferring the detection result to the network host and creating a driver package by the network host from the driver database in accordance with the detection result, and transferring the driver package to the data processing machine and executing the driver package to accomplish the driver installation operation.

A second respect of the present invention is directed to a system for accomplishing online PnP driver installation operation, comprising a network host and a data processing machine communicating with the network host through a computer network, wherein the PnP driver can be installed or updated in a data processing machine from the network host. The network host includes a data storage unit configured for retaining a driver database and creating a driver package from the driver database in accordance with a detection result generated by a driver detection program, and a network connection unit electrically coupled to the data storage unit for enabling the network host to establish a connection with the data processing machine through the computer network to proceed with data transfers. The detection result is generated by executing a driver detection program and is transferred to the network host by the network connection unit, and the driver package is transferred to the data processing machine by the network connection unit and executed by the data processing machine.

The other objects, features and advantages of the present invention will become more apparent through the following descriptions with reference to the drawings attached hereto, wherein:

### BRIEF DESCRIPTION OF THE DRAWINGS

FIG. 1 is a control flowchart illustrating the method for online PnP driver installation through a computer network according to a first preferred embodiment of the present invention;

FIG. 2 is a control flowchart illustrating the method for online PnP driver installation through a computer network according to a second preferred embodiment of the present invention; and

FIG. 3 is a schematic diagram showing the architecture of the entire system for accomplishing online PnP device driver installation operation according to the present invention.

### DETAILED DESCRIPTION OF PREFERRED EMBODIMENTS

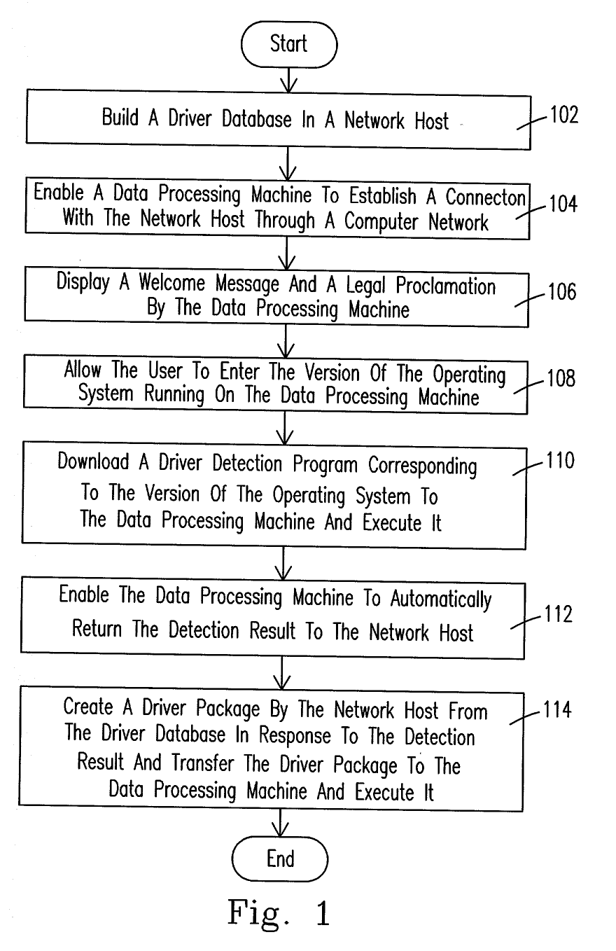

Several preferred embodiments of the present invention will be addressed in the following with reference to the accompanying drawings. Referring now to FIG. 1, a flowchart illustrating the method for online PnP driver installation through a computer network according to a first preferred embodiment of the present invention is shown. The driver installation process according to a first preferred embodiment of the present invention starts from step 100. At step 102, a driver database is built in a network host. The driver database contains drivers of various hardware devices for different operating systems, a driver detection program that detects the status of the driver installation operation and a driver installation program that installs or updates the desired hardware device driver. If the user of a data processing machine, such as a personal computer or a workstation, desires to install or update a hardware device driver when a new PnP device is added to the data processing machine, for example, the user may establish a connection between the data processing machine and the network host through a computer network (which can be a local area network or Internet). Subsequently, at step 106 a welcome message and a legal proclamation are displayed by the data processing machine. At step 108 an input form is provided for the user to enter the information associated with the version of operating system running on the data processing machine, and the inputted information is transferred to the network host. Thereafter, at step 110 a driver detection program corresponding to the version of the operating system running on the data processing machine is downloaded from the network host to the data processing machine, and is executed by the data processing machine to generate a detection result. Next at step 112 the detection result is automatically returned from the data processing machine to the network host. At step 114, a driver package is created from the driver database retaining in the data processing machine in accordance with the detection result, and is transferred to the data processing machine. When the driver packaged has been executed by the data processing machine, the online PnP driver installation process is completed thereupon. Hence, when the data processing machine receives the batch archives containing in the driver package and executes it, the drivers that are needed to be installed or updated will be automatically installed or updated after the batch archives is put into execution. In addition, the driver package may be presented in a batch archives or the like containing one or more drivers that are needed to be installed or updated and the driver installation program that is used to proceed with driver installation operation. On the other hand, the driver installation program may be a single program. However, because the support for the driver installation process is different from operating system to operating system, this issue should be taken into consideration in the driver installation program development.

With the introduction of online PnP driver installation process according to the present invention, the user does not need to download the complete and inseparable driver package of huge data amount that is furnished with numerous hardware device drivers, but can automatically detect the category and number of drivers that are requested by the user. Therefore in the first preferred embodiment of the present invention, the driver installation or update operation can be automatically accomplished by downloading the driver detection program and the batch archives only, so that the download data amount and download time can be efficiently reduced. In general, the data amount of a driver package is ranged from several megabytes to tens of megabytes. In accordance with the present invention, the data amounts of the driver detection program and the driver installation program are about 10 kilobytes and 4 kilobytes respectively. Even the driver of several kilobytes is taken into account, the download data amount according to the present invention is far less than that according to the prior art. In this manner the download time and the time necessary to display welcome message and legal proclamation according to the present invention are shorter than the prior art. Furthermore, because the welcome message and the legal proclamation are display for one time according to the present invention (at step 106), it will not put the user to annoyance due to the repetitive display of the welcome message and the legal proclamation for each driver installation process in the prior art.

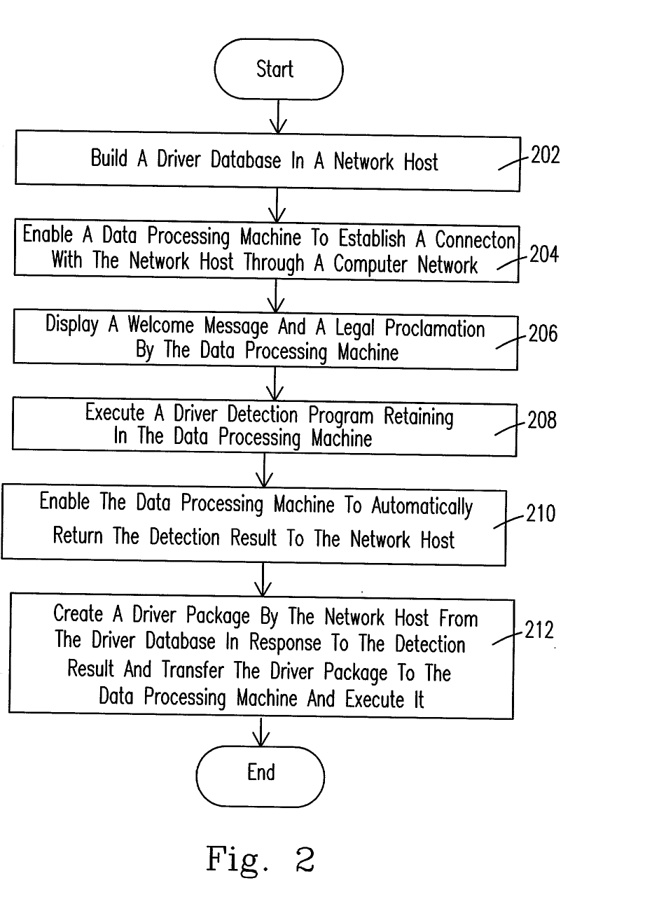

Turning now to FIG. 2, a flowchart depicting the method for online PnP driver installation through computer network according to a second preferred embodiment of the present invention is shown. Similarly, at step 202 a driver database containing drivers of various hardware devices for different operating systems and a driver installation program is built in the network host. When the user of the data processing machine desires to install or update a hardware device driver, at step 204 the data processing machine is enabled to establish a connection with the network host through a computer network. After the welcome message and legal proclamation haven been displayed by the data processing machine at step 206, the driver detection program will be executed to automatically detect the category and number of drivers that are requested by the user to be installed on the data processing machine, and further a detection result is generated at step 208. At step 210, the detection result is automatically transferred from the data processing machine to the network host. The network host creates a driver package from the driver database in accordance with the detection result and transferred the driver package to the data processing machine. At step 212, when the data processing machine receives the driver package and executes the batch archives containing in the driver package, the drivers that are to needed to be installed or updated will automatically installed or updated. The driver package according to a second preferred embodiment of the present invention is physically represented by a batch archives. Unlike the foregoing first preferred embodiment, the detection program according to the second preferred embodiment is retained in the data processing machine, and the detection result being transferred to the network host will be indicative of the information associated with the version of operating system running on the data processing machine.

Because the driver detection program is retained in the data processing machine according to the second preferred embodiment of the present invention, it can be configured in the data processing machine concurrently with the initial driver installation process using the driver installation CD encased with the hardware device in a package. Besides, the driver detection program can be set to be auto-update enabled, and can drive the data processing machine to automatically connect to the network host to transfer the detection result upon the successful connection between the data processing machine and the computer network. On the other hand, in order to increase the network connection security for the communications over the computer network, a user authorization step may be set forth before each driver installation or update operation to generate the authentication data from the user (preferably, the user authorization step can be put into action prior to step 112 or step 210), and thus avoid unnecessary downloads due to the affection on the data processing machine being infected with computer virus.

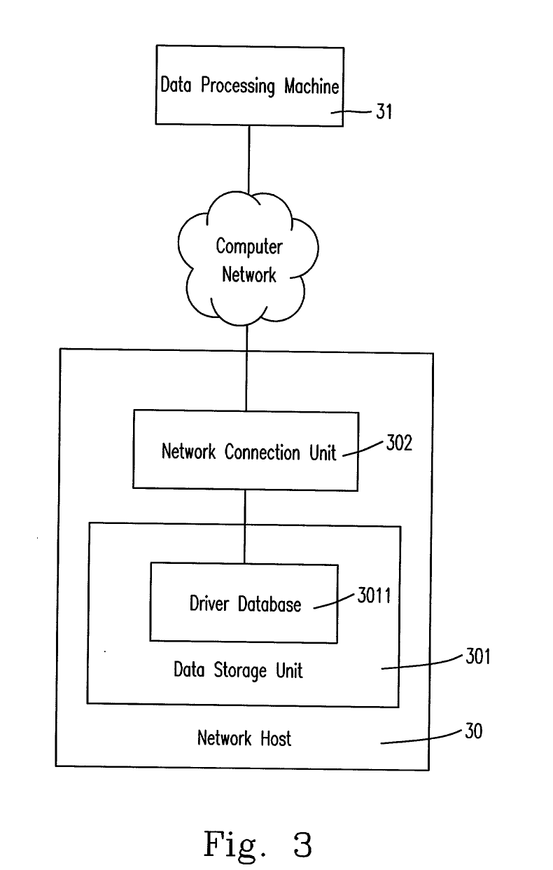

FIG. 3 depicts the functional block diagram of the entire system for accomplishing online PnP driver installation process, wherein the data processing machine, such as personal computer, workstation or personal digital assistant (PDA) device communicates with the network host 30 through a computer network. The network host 30 includes a data storage unit 301 and a network connection unit 302, in which the data storage unit 301 contains a driver database 3011 and retains the information associated with the welcome message and legal proclamation to be displayed. The driver database 3011 contains drivers of various hardware devices for different operating systems, a driver detection program and a driver installation program. When it is desirous to install or update a hardware device driver (for example, install a PnP driver or download the hardware device driver of new version), it may go along after the fashion of which is depicted in the control flowchart of FIG. 1 or FIG. 2. For instance, when the data processing machine 31 establishes a connection with the network host 30 through the computer network at step 104 or 204, the network host 30 can display welcome message and legal proclamation by the data processing machine at step 106 or 206. The online driver installation process may continue with step 208 of FIG. 2 in which the detection program retaining in the data processing machine 31 is executed, or alternatively continues with step 108 of FIG. 1 in which the user is allowed to enter the information associated with the version of operating system running on the data processing machine and with step 110 in which a driver detection program corresponding to the version of the operating system is downloaded to the data processing machine 31 and executed by the data processing machine 31. Subsequently, the driver detection program detects the category and number of the drivers that are requested by the user to be installed or updated to generate a detection result. The driver detection program drives the data processing machine 31 to automatically return the detection result to the network host 30 at step 112 or 210, such that the network host 30 creates a driver package from the driver database 3011 in accordance with the detection result. Next the driver package is transferred to the data processing machine 31 and executed by the data processing machine 31 to accomplish the online driver installation process at step 114 or 212. As regards the batch archives included in the driver package, it is retained in the data storage unit 301, or can be retained in the driver database 3011 depending on practical applications.

It is obvious from the above that the online driver installation process as fully illustrated by the embodiments of the present invention provides a fast and convenient way to configure a hardware device in a data processing machine. The drawbacks of considerable download data amount and overlong download time in the prior online driver installation process can be thoroughly eliminated through the use of the present invention. It should be noted that although the present invention has been described and illustrated in detail, it is to be clearly understood that the same is by the way of illustration and example only. The spirit and scope of the present invention can only be defined by the terms of the appended claims.

What is claimed is:

1. A method for configuring a hardware device in a data processing machine from a network host, said method comprising the steps of:
enabling said data processing machine to establish a connection with said network host through a computer network, wherein said network host is coupled with a driver database;
executing a driver detection program by said data processing machine to generate a detection result;
creating a driver package from said driver database in accordance with said detection result being transferred to said network host; and
transferring said driver package to said data processing machine and executing said driver package by said data processing machine.

2. The method of claim 1 wherein said detection result is indicative of a category and a number of drivers requested by said data processing machine.

3. The method of claim 1 wherein said driver detection program is retained in said data processing machine, and said detection result is further indicative of information associated with the version of an operating system running on said data processing machine.

4. The method of claim 1 wherein said driver database contains a plurality of drivers and a driver installation program.

5. The method of claim 4 wherein said driver package is a batch archives containing at least one of said plurality of drivers and said driver installation program.

6. The method of claim 1 wherein said driver detection program is retained in said network host, and said detection result is further indicative of information associated with a version of an operating system running on said data processing machine.

7. The method of claim 1 wherein after said data processing machine is connected with said network host through said computer network, said method further comprises a step of displaying a welcome message and a legal proclamation by said data processing machine.

8. The method of claim 7 wherein said welcome message and said legal proclamation are display for one time.

9. A method for configuring a plug-and-play hardware device in a data processing machine from a network host, said method comprising the steps of:
enabling said data processing machine to establish a connection with said network host through a computer network, wherein said network host is coupled with a driver database;
displaying a welcome message and a legal proclamation by said data processing machine for one time;
executing a driver detection program by said data processing machine to generate a detection result;
creating a driver package from said driver database in accordance with said detection result being transferred to said network host, wherein said driver package contains drivers requested by said data processing machine and a driver installation program; and
transferring said driver package to said data processing machine and executing said driver package by said data processing machine.

10. The method of claim 9 wherein said detection result is indicative of a category and a number of drivers requested by said data processing machine.

11. The method of claim 10 wherein said driver detection program is retained in said data processing machine and said detection result is further indicative of a version of an operating system running on said data processing machine.

12. The method of claim 9 wherein said driver database contains a plurality of drivers and a driver installation program.

13. The method of claim 9 wherein said driver detection program is retained in said network host and said detection result is further indicative of information associated with a version of an operating system running on said data processing machine.

14. The method of claim 9 wherein said driver package is a batch archives.

15. A network host for configuring a plug-and-play hardware device in a data processing machine through a computer network, comprising:
a data storage unit retaining a driver database containing a plurality of drivers and a driver installation program, and is configured for creating a driver package from said driver database in accordance with a detection result, wherein said driver package at least contains one of said plurality of drivers and said driver installation program; and
a network connection unit coupled to said data storage unit for enabling said network host to establish a connection with said data processing machine through said computer network to proceed with data transfers;
wherein said detection result is generated by executing a driver detection program and is transferred to said network host by said network connection unit, and said driver package is transferred to said data processing machine by said network connection unit and executed by said data processing machine.

16. The network host of claim 15 wherein said driver package is a batch archives.

17. The network host of claim 15 wherein said detection result is indicative of a category and a number of drivers requested by said data processing machine.

18. The network host of claim 17 wherein said driver detection program is retained in said data processing machine and said detection result is further indicative of a version of an operating system running on said data processing machine.

19. The network host of claim 15 wherein said data processing machine is enabled to display a welcome message and a legal proclamation by said data processing machine for one time when said data processing machine is.

20. The network host of claim 15 wherein said driver detection program is retained in said data storage unit, and said network host is provided to receive information associated with a version of an operating system running on said data processing machine to download said driver detection program corresponding to said information to said data processing machine.
